(19) United States
(12) Patent Application Publication
(10) Pub. No.: US 2019/0059131 A1
(43) Pub. Date: Feb. 21, 2019

(54) GLASS CERAMIC WORKTOP

(71) Applicant: EUROKERA S.N.C., Chateau-Thierry (FR)

(72) Inventors: Gregory DEBREYER, Montcourt Fromonville (FR); Franck DEMOL, Reims (FR); Nicolas ROUX, Chateau-Thierry (FR); Pablo VILATO, Paris (FR)

(73) Assignee: EUROKERA S.N.C., Chateau-Thierry (FR)

(21) Appl. No.: 15/756,650

(22) PCT Filed: Sep. 6, 2016
(86) PCT No.: PCT/FR2016/052213

§ 371 Date: Mar. 1, 2018

(30) Foreign Application Priority Data
Sep. 8, 2015 (FR) 1558343

(51) Int. Cl. H05B 3/74; C03C 10/00; F24C 15/10; A47B 96/18

(52) U.S. Cl. CPC H05B 3/74; C03C 10/00; C03C 2204/04; A47B 96/18; F24C 15/10

(57) ABSTRACT

An item of equipment includes at least one worktop formed of at least one substrate made of monolithic glass material with a surface area of greater than 0.7 m². The substrate exhibits a luminosity L* of greater than 10, a light transmission T_{L} of less than 50%, and an opacity indicator of greater than 90. The item of equipment also includes at least one heating element and at least one interface for communication with at least one element of the worktop, such as the heating element(s), and/or with at least one external element for wireless communication. The item of equipment is devoid of light source(s).

The present invention relates to a worktop, or work table or counter or piece of furniture, formed of at least one large-sized plate positioned or intended to be positioned horizontally on one or more supporting elements (casing of a piece of furniture, supporting leg(s)) in order to provide a stable surface intended for different uses. In particular, the present invention relates to a table or a piece of furniture exhibiting a surface or platform (generally horizontal in the position of use) capable of making possible, simultaneously or successively, different activities and/or support for objects (this surface or platform thus forming what is known as a worktop), in particular which can make possible the cooking or the reheating of food in appropriate containers and provide other uses.

The materials normally used to produce worktops are, for example, wood, quartz, Corian® and the like. For the cooking of food, there furthermore exist large-sized cooking surfaces in kitchens, in particular for professional use, these plates generally being metal and/or composite plates. In particular, there exist multilayer panels, based on ceramic layers or materials, such as stoneware, on metal layers or materials of aluminum type or on insulating plastic layers or materials of Bakelite type, these panels generally exhibiting a high thickness (of the order of 12 mm, for example) and being complex to produce.

At the same time, cooking tops made of materials of strengthened glass or glass-ceramic type, of more limited dimensions (in particular with a surface area generally of less than 0.4 m², it being possible for plates with a greater surface area to be more difficult to obtain by the processes normally used and to present problems in terms of flatness, handling, and the like), exist, in particular for domestic uses, the use of glass-ceramic material having become widespread in recent years for cooking plates, due in particular to the performance qualities of this material for this use and the attractive appearance of the plates produced.

There currently exist different types of glass-ceramic plates, each variant being the result of major studies and of numerous tests, given that it is very problematic to modify these plates and/or the process by which they are produced without the risk of having an unfavorable effect on the properties desired: in order to be able to be used as cooking plate, a glass-ceramic plate generally has to exhibit a transmission in the wavelengths of the visible region which is both sufficiently low to conceal at least a portion of the underlying heating elements when turned off and sufficiently high for, depending on the situation (radiant heating, induction heating and the like), the user to be able to visually detect the heating elements in the operating state for the purpose of safety; it should also exhibit a high transmission in the wavelengths of the infrared region in the case in particular of plates having radiant heating elements. The plates thus designed are intended exclusively for use as cooking plates and are conventionally neither intended to receive objects other than the heat-resistant utensils used for the cooking of food nor intended for the practice of activities other than the cooking of food.

The present invention has sought to widen the range of the existing household equipment products, having domestic or professional use, by developing interactive products of a novel type making possible more varied uses.

This aim has been achieved by the novel item of equipment or article or installation according to the invention, which is advantageously interactive, this item of furniture/household equipment (or piece of furniture) comprising:
at least one worktop (or work counter or work table) formed of at least one substrate (in particular plate or surface or platform) made of (or based on or of a or essentially composed of a) monolithic (or monoblock or with just one supporter) glass material (preferably made of glass-ceramic), which is advantageously essentially flat, with a surface area (length times width of its face with the greatest dimensions) of greater than 0.7 m², said substrate exhibiting a luminosity (or lightness) L* of greater than 10, a light transmission T_{L} of less than 50%, an opacity indicator of greater than 90 and, if appropriate, a haze of greater than 15%,
at least one heating element (in particular under the substrate and hidden by the latter when this heating element is not in operation/is turned off),
at least one interface for communication with at least one element of the top (for example with the heating element(s)) and/or, if appropriate, with at least one external element (outside the top), for example with an external module (unit, device), for wireless communication, said item of equipment additionally being devoid of light source(s) (or source(s) having an (exclusively) illumination use).

The product developed according to the invention meets the desired aim, the present invention thus providing a novel interactive item of equipment (making possible in particular the activation of functions, such as the cooking of food) which can be used just as well in the kitchen as in another habitable room, it being possible for the worktop to form part of an uninterrupted or interrupted piece of furniture, of a table, of a counter, and the like, this worktop being mounted or capable of being mounted horizontally on (in particular on the top of) one or more supporting elements (casing of a piece of furniture, supporting leg(s)) in order to provide a stable surface intended for different uses, the worktop or the item of equipment according to the invention exhibiting a continuous upper surface capable of making possible, simultaneously or successively, activities (such as work, games, reading, and the like), the support for objects (such as pieces of paper, computers, vases, dishes, and the like) and the preparation or the cooking or the reheating of food in appropriate containers.

More generally, the invention also relates to a worktop formed of at least one substrate made of monolithic glass material with a surface area of greater than 0.7 m², said substrate exhibiting a luminosity L* of greater than 10, a light transmission T_{L} of less than 50%, an opacity indicator of greater than 90 and, if appropriate, a haze of greater than 15%, this worktop being intended to equip a multiuse interactive piece of furniture or item of equipment (intended for multiple uses, such as are listed in the preceding paragraph) as defined above according to the invention.

The invention also relates to the use of a substrate, in particular of a plate, made of monolithic glass material, with a surface area of greater than 0.7 m² made of glass material, said substrate exhibiting a luminosity L* of greater than 10, a light transmission T_{L} of less than 50%, an opacity indicator of greater than 90 and, if appropriate, a haze of greater than 15%, as multiuse interactive worktop as mentioned in the paragraphs above.

As indicated above, the worktop is formed of a large-sized substrate or plate made of monolithic glass material (the glass material having been formed of a single block/as a single part, even though the substrate can, if appropriate, exhibit recesses, generally produced in the part after it has been formed, for esthetic or functional purposes), the advantage of such a large-sized monolithic plate being in particular that of providing a predominantly continuous/uniform/join-free surface which is attractive and easy to maintain, and also greater comfort of use and greater safety (in terms of impermeability, in the event of spilling liquids, and the like), and the like. The substrate essentially, indeed even solely, comprises the glass material, it being possible for this substrate/glass material, if appropriate, to be provided with thin decorative or functional coatings (in particular of the order of a few tens of nanometers to a few hundred microns, indeed even more, in thickness), for example made of enamel, paint, thin layers, and the like, as specified subsequently.

Contrary to the practice in the field of glass-ceramics in particular, this (substrate made of) glass material is large-sized, its surface area (corresponding to the product of its length by its width for its face having the largest dimensions—generally its upper face, which is intended to be visible and to act as support for (household or working or cooking) articles) having dimensions of greater than 0.7 m², preferably of greater than 0.9 m², in particular of greater than 1 m² and especially of greater than or equal to 2 m². In point of fact, the manufacture of large plates, in the case of glass-ceramics in particular, presents numerous problems as regards flatness and handling. In the present invention, a large-sized plate, even so exhibiting a good flatness, can nevertheless advantageously be obtained by reducing the rate of passage (or lengthening the ceramization furnace or increasing the residence time in the furnace), with respect to the speed (or to the standard length of the furnace or to the standard time) normally used to obtain glass-ceramic plates of normal dimensions of less than 0.4 m², as explained subsequently in the process according to the invention.

In the present invention, the substrate made of glass material thus advantageously forms the major part (at least 50%), indeed even all, of the worktop or of its surface or face intended to be used for various purposes (generally upper face in the position of use). In particular, the substrate made of glass material advantageously occupies, in the present invention, at least 50%, in particular at least 70%, especially at least 90%, of the surface (generally measured on the upper face, intended to be visible and to be used as support for articles) of the worktop, and it generally occupies the entire surface of the worktop, the surface of the worktop being understood as the uninterrupted surface occupied by the worktop (surface which it occupies with the exclusion of that/those occupied by possible recesses (such as a recess in the top for incorporating a sink)) on the face under consideration (generally its upper face, intended to be visible and to act as support for articles), indeed even being understood in particular as the overall surface corresponding to the product of the length of the worktop by its width). Depending on the type of piece of furniture (in particular in the case of a piece of furniture where the worktop occupies the whole of one of its faces, generally the upper face, for example a table, a central island or a simple worktop), the substrate made of glass material can thus also occupy at least 50%, in particular at least 70%, especially at least 90%, of the surface of a face, in particular of the upper face (in the position of use), of the piece of furniture, indeed even occupy all of said surface.

Advantageously, the substrate made of glass material forms at least 50%, in particular at least 70%, especially at least 90%, indeed even the whole, of the worktop or, in other words, the worktop (generally on the upper face or forming the upper face of the piece of furniture) is mainly (to at least 50%, in particular at least 70%, especially at least 90%), in particular entirely (or solely), formed of (or constituted by the, or consists of the) substrate made of glass material (this glass material preferably being glass-ceramic).

The substrate/glass material according to the invention is advantageously flat (or predominantly or virtually flat) and in particular exhibits a flatness (height between the highest point and the lowest point of the substrate, with respect to the mean plane of the substrate, excluding any possible deliberate deformations produced on the substrate for esthetic or functional purposes) of less than 0.1° A of the diagonal of the substrate and preferably of less than 3 mm, in particular of less than 2 mm, especially of less than 1 mm, indeed even of the order of zero, depending on the size/surface area/diagonal of the substrate, the flatness being measured using a SurFlat reference waviness meter sold by Visuol. The substrate is generally of geometric shape, in particular rectangular, indeed even square, indeed even circular or oval, and the like, and generally exhibits an “upper” face (face which is visible) in the position of use, another “lower” face (generally hidden, in the framework or casing of the piece of furniture incorporating the worktop) in the position of use, and an edge face (or edge or thickness). The upper face is generally flat and smooth but may also exhibit at least one protruding zone and/or at least one recessed zone and/or at least one opening and/or beveled edges (these shapes having been added during the manufacture of the substrate, for example by rolling, gravity bending or pressing, and the like, or having been added in off-line operations), and the like, these variations in shape advantageously constituting continuous variations in the plate (without change in materials or joins). The lower face can in particular be smooth or provided with tear drops increasing its mechanical strength and obtained, for example, by rolling.

The thickness of the monolithic substrate made of glass material used is generally at least 2 mm, in particular at least 2.5 mm, especially is of the order of 3 to 30 mm, and advantageously is less than 15 mm, especially is of the order of 3 to 15 mm and in particular of 3 to 10 mm.

The glass material of the substrate used is advantageously resistant to high temperatures and/or exhibits an expansion coefficient of zero or virtually zero (for example of less than 15.10⁻⁷ K⁻¹) and in particular is advantageously glass-ceramic or a strengthened (in particular chemically or thermally tempered) glass. Preferably, the substrate is a substrate made of glass-ceramic. As defined according to the invention, the substrate is advantageously opaque and/or not very transmitting, while being scattering and sufficiently clear (the clarity being given by the luminosity L*), the glass material being in particular colored or tinted in its bulk (this coloring including white and all the colors with a luminosity L* of greater than 10, the darker colors, such as black or dark brown, being excluded), as specified below.

The glass-ceramic used can in particular have a composition as described in the patent applications published under the following numbers: EP1300372, U.S. Pat. No. 6,706,653, WO9906334, WO2007113242, EP1840093, US2007213192, U.S. Pat. No. 7,476,633, JP2009531261, WO2012156444, WO2012001300, DE202012011811, this glass-ceramic being in particular a lithium aluminosilicate glass-ceramic and also advantageously comprising colorants.

Use is advantageously made, for example, of a glass-ceramic comprising the following constituents and/or obtained by ceramization starting from a glass with the following composition, within the limits below, expressed as percentages by weight: SiO₂: 52-75%; Al₂O₃: 18-27%; Li₂O: 2.5-5.5%; K₂O: 0-3%; Na₂O: 0-3%; ZnO: 0-4%; MgO: 0-5%; CaO: 0-2.5%; BaO: 0-3.5%; SrO: 0-2%; TiO₂: 0-5.5%; ZrO₂: 0-3%; P₂O₅: 0-8%; B₂O₃: 0-5%, and preferably, within limits below, expressed as percentages by weight: SiO₂: 55-70%; Al₂I₃: 18-24%; Li₂O: 2.5-4.5%; K₂O: 0-2.0%; Na₂O: 0-2.0%; ZnO: 1.5-4%; MgO: 0.20-5%; CaO: 0-1%; BaO: 0-3%; SrO: 0-1.4%; TiO₂: 1.8-5%; ZrO₂: 0-2.5%; P₂O₅: 0-8%; B₂O₃: 0-5%, this composition also comprising, if appropriate, additional colorants.

The glass-ceramic may be refined with arsenic (that is to say, have (a mother glass with) a composition comprising of the order of 0.2% to 1.5% by weight of arsenic oxide (expressed as As₂O₃)) or may not be refined with arsenic (in particular exhibiting a content of arsenic oxides of less than 0.2%, in particular of less than 0.1%, indeed even zero) or refined with tin or refined with sulfide(s), and may be obtained by rolling or by the float glass process.

The glass material can also be a nonceramized tempered glass, for example a tempered lithium aluminosilicate colored in its bulk, such as described in the patent application filed in France under the number 1 260 354, or else a tempered glass of another type (soda-lime, borosilicate, and the like), advantageously colored in its bulk.

The glass-ceramic or the tempered glass are obtained by the respective processes described in the abovementioned documents using the treatment temperatures and cycles which make it possible to obtain the glass material exhibiting the selected characteristics given in the definition of the invention. In the case of the glass-ceramics, these processes are preferably modified by reducing the rate of passage by at least 25%, preferably by at least 50%, or by increasing the length of the ceramization furnace or the residence time in said furnace by at least 25%, preferably by at least 50%, with respect to the rates, lengths and times, respectively, normally used, in order to obtain a large-sized flat substrate as required according to the invention, as explained subsequently.

As defined according to the invention, the substrate forming the worktop is selected so as to exhibit a luminosity L* of greater than 10, preferably of greater than 15 (in particular of greater than 30), if appropriate (for a nonzero T_{L}/a nonopaque substrate) a haze of greater than 15%, in particular of greater than 20%, indeed even of greater than 40%, indeed even of greater than 80%, a light transmission T_{L} of less than 50%, in particular of less than 32%, it being possible for this light transmission to be, if appropriate, zero in the case of a completely opaque glass material, and an opacity indicator of greater than 90, preferably of greater than 95 (this indicator being less than or equal to 100). The substrate exhibits these characteristics over the majority (in particular over at least 80%, indeed even over 100%) of its surface, except for possible localized decorations (for example made of enamel) or localized components applied to its surface.

These properties are generally those of the glass material forming the substrate in itself, without the presence of any one coating, but, if appropriate, can result from the combination of the glass material and of a coating applied on the majority of the one and/or the other of its main faces. Advantageously, there are characteristics intrinsic to the substrate made of glass material, that is to say that said substrate made of glass material exhibits these characteristics in itself without the presence of any one coating.

The luminosity L* is a component defined in the CIE colorimetric system and is evaluated in a known way, using in particular a Byk-Gardner Color Guide 45/0 colorimeter (colorimetry in reflection), on the upper face of the substrate placed on an opaque white background.

The haze measures the level of light scattering and is defined, in the context of the invention, as being the ratio of the diffuse transmission to the total transmission at a wavelength equal to 550 nm, this haze being evaluated, for example, using the spectrophotometer equipped with an integrating sphere used for the light transmission measurements, this haze being evaluated for a nonzero light transmission/a nonopaque glass substrate.

The light transmission T_{L} is measured according to the standard ISO 9050:2003 using the illuminant D65 and is the total transmission (integrated in the visible region), taking into account both direct transmission and possible diffuse transmission, the measurement being carried out, for example, using a spectrophotometer equipped with an integrating sphere, the measurement at a given thickness subsequently being converted, if appropriate, to the reference thickness of 4 mm according to the standard ISO 9050:2003.

The opacity indicator (or factor or coefficient) Ω is determined in the present invention by the formula Ω=100−ΔE* and is evaluated by measuring (colorimetry in reflection carried out using a Byk-Gardner Color Guide 45/0 colorimeter) the variation in color ΔE*, corresponding to the difference between the color, measured in reflection on the upper face of the substrate, for the substrate placed on an opaque white background and the color for the substrate placed on an opaque black background (ΔE*=((L_{B}*−L_{W}*)²+(a_{B}*−a_{W}*)²+(b_{B}*−b_{W}*)²)^{1/2}, L_{W}*, a_{W} * and b_{w}* being the color coordinates of the first measurement on the white background and L_{B}*, a_{B}* and b_{B}* being those of the second measurement on the black background in the colorimetric system established by the CIE in 1976).

The substrate according to the invention as defined above has in particular a relatively clear and scattering opaque (and/or not very transmitting) colored appearance, in particular is colored or tinted in its bulk, this coloring including white and all the colors with a luminosity L* of greater than 10, the darker colors, such as black or dark brown, being excluded, this material making it possible, inter alia, to signal the cooking zones, when they are in the operating state, while masking, in one and the same step, the elements placed below (such as the heating elements and cables). Advantageously, the glass material forming the substrate is translucent or opaque (in particular it exhibits a light transmission T_{L} of less than 50%, in particular of less than 32%); it can in particular be white, cream, indeed even gray, purple in color, or of another color (except for black and dark brown), translucent or opaque.

The substrate is preferably based on a translucent or opaque and white or cream glass-ceramic generally comprising crystals of p-spodumene structure within a residual vitreous phase, the absolute value of its expansion coefficient being in particular of the order of 10.10⁻⁷/° C. to 15.10⁻⁷° C., and exhibiting the abovementioned characteristics, such as the glass-ceramic of the plates sold under the KeraWhite, KeraWhite TC or KeraBiscuit name by Eurokera.

The substrate or glass material can, if appropriate, comprise colorants giving specific colorings (for example purple, green, gray, and the like), at contents preferably of less than 10% by weight, for example vanadium oxide, iron oxide, cobalt oxide, cerium oxide, selenium oxide, chromium oxide, indeed even nickel oxide, copper oxide and/or manganese oxide, and the like.

Alternatively or jointly, the glass material can also be provided with a coating confering on it a coloring different from its own coloring (or intrinsic coloring), for example can be provided with at least one coat of paint on at least a portion or the majority or all of one of its main faces (in particular the lower face), for example at least one coat of paint of pistachio, gray, blue, yellow, red, and the like, color. The paint used preferably exhibits a thermal resistance of greater than 350° C. (generally of between 350° C. and 500° C.) and is, for example, based on silicone resin(s), in particular on silicone alkyd resin(s) (that is to say, one or more silicone resins modified by the incorporation of alkyd resin(s)), indeed even can be based on other resins, such as epoxy or polyurethane resins, for uses at low temperatures of less than 200° C., this paint comprising, for example, pigments, preferably pigments for enamels (in proportions not exceeding 50% by weight), according to the coloring desired. Other coatings can also be used (for this purpose or for other purposes, for example for decorative patterns), for example enamel, thin layers, as indicated subsequently.

As defined above, the article according to the invention also comprises at least one heating element, for example one or more radiant or halogen heating elements or one or more gas burners and/or one or more inductive heating means, these heating means generally being located under the worktop and hidden by the latter when turned off. The worktop of the article according to the invention can comprise one or more heating elements as well as one or more stove top burners. The term “stove top burner” is understood to mean a cooking location. The article according to the invention can comprise several types of heating elements or stove top burners (stove top gas burners, stove top radiant burners, halogen stove top burners or inductive stove top burners). Preferably, the article according to the invention comprises, as heating element(s), one or more inductive heating means.

The heating mean(s) can be located in a defined zone (for example on one end of the plate) or several zones of the substrate or can be uniformly distributed under the substrate, for example occupying at least 25% of the surface area of the substrate, indeed even can occupy a surface area virtually equivalent to that of the substrate (for example more than 50%, in particular more than 75%, indeed even more than 85%, indeed even 100%, of the main surface area of the substrate), a plurality of small-sized inductors, for example, lining the substrate under its lower face, in order to make possible heating, if necessary, in any zone.

The cooking locations on the worktop, straight above the heating means, can be signaled (or not, in the case, for example, of a top equipped with heating means covering the whole of its areal extent), on activation and/or permanently, in particular by means of a permanent decoration, for example made of enamel. The patterns making it possible to signal the cooking zones (as well as patterns which may signal other zones or functions or form decorations) can be larger or smaller in size; for example, they may be circles, each delimiting heating elements, or small patterns (triangles, crosses, and the like) at the center thereof or at the base thereof, and the like. The absence of light sources, integrated in the item of equipment, in order to signal, for example, the heating zones (the latter being signalled, if need be, by fixed patterns in the present invention) or in order to illuminate displays or to cause other light effects, exhibits the advantage of being more economical, of making it easier to maintain the item of equipment, of offering greater safety and simplicity in the handling of the item of equipment, said item of equipment generally being intended to be used in environments which are already provided with illumination means (natural or artificial illumination means, such as a living room, a terrace, and the like).

Preferably, the cooking locations (and/or, if appropriate, other zones and/or elements and/or functions and/or decorations) are thus signaled permanently by a fixed pattern (in particular of round circle, cross, triangle, rectangle, or other nongeometric decoration, and the like, type), in particular obtained by deposition of layer(s) (especially such as those used for the decoration of glass-ceramics), for example made of enamel or optionally paint, at the surface of the plate (in particular on the upper face, or optionally on the lower face according to the type of coating). As indicated above, the item of equipment according to the invention also comprises at least one interface for communication with at least one element of the top (such as the heating element(s)) and/or with an element external to the top, for example for wireless communication.

This (in particular man-machine or machine-machine) communication interface can be a device which makes it possible in particular to control or to transmit commands to the heating elements from or via control buttons or keys integrated into the worktop or offset onto an external element which is advantageously detachable or movable, in the case in particular of a command by wireless communication.

Preferably, the interface makes possible wireless communication with a unit external to the worktop (it being possible for this unit to form part of the item of equipment according to the invention and to itself constitute an interface), for example making possible the remote activation of the heating zones and/or the control of different functions (increase or decrease in the power or in the heating time, and the like), the commands given by the external unit being transmitted by the interface to the relevant components of the item of equipment. The interface can also be a control interface located on the top (control panel) which transmits the commands by wires or optionally wirelessly to other components of the top or outside the top.

The external unit in the case of remote control can, for example, be in the form of a keyboard, a tablet, a touch screen or a cellphone, it being possible for this unit to be stationary (for example fastened to a wall) or movable (being able, if appropriate, to be placed on the worktop). This embodiment exhibits in particular the advantage of preventing finger marks (which are unsightly and obvious on glass materials) on the worktop or the cooking zones. Remote activation of the controls also makes it possible to reduce the risks of burns as the controls close to the cooking zones are not handled. For the sake of safety in particular, the wireless communication can advantageously be planned to be of limited range (for example range limited to the volume of the room in which the item of equipment is located) and/or equipped with safety features in order to prevent inadvertent activation by a person not present. The wireless communication in particular is achieved via electromagnetic or radio waves, if appropriate using systems of Bluetooth, WLAN, Wi-Fi, RFID chip, and the like, type.

The interface can make it possible to transmit different signals initiated by contact or even by movement in order to activate different components (for example, it may convert a movement, detected by sensors by triangulation, these sensors being connected to this interface (and if appropriate forming part thereof), into the activation of a function (for example the increase in the heating power, and the like)).

At least one interface is generally located on or under the worktop or close by. The item of equipment according to the invention can also comprise several interfaces, of the same type or different types, for example making possible the activation of different elements, or the item of equipment can comprise several interfaces, if appropriate functioning differently (of different composition, operating at different frequencies, and the like), for managing one and the same element (for example a heating zone) with a higher level of safety. The interface can be formed of sensor(s), connector(s), control element(s), any other electrical or electronic or electromagnetic component, and the like. One or more control means or zones (in the form of keys, logos, indeed even keyboards, and the like) or indicators (of intensities/of power, of time, and the like), which are, for example, capable of being activated by contact on the surface of the top or remotely (in particular by wireless communication), or by simple movement of the hand, as already mentioned (by sensors located, if appropriate, on the exterior and recording the movement, for example by triangulation, in order to convert it, in particular using an appropriate algorithm and an appropriate interface, into the activation of a function, for example), or, if appropriate, by placing a predetermined object (saucepan, and the like) at a predetermined location (such as a cooking zone) of the plate, can be connected to or form part of the interface(s).

Preferably, the item of equipment according to the invention comprises at least one interface for communication with at least one external element for the activation of different zones and/or functions of the substrate by wireless communication, in particular when the light transmission T_{L} of the substrate is low (in particular less than 10%).

Apart from the interface, the item of equipment or worktop can be equipped with different cables, connectors or other elements, in particular of electrical nature, which contribute to the transmission of commands from one part of the item of equipment to the other.

The item of equipment, in particular among the worktop, according to the invention can also comprise various functional and/or decorative coatings, in particular among those generally used with the glass materials in question, for example based on enamel, on paint, on thin (for example metal, dielectric, and the like) layer(s), and the like. For example, one of the faces of the substrate can comprise one or more enamel layers or one or more enamel patterns having a decorative purpose and/or in order to signal one or more elements (display devices, cooking zones, and the like) and/or acting as coloring layer (as seen above) or as masking layer (in order to prevent, for example, the elements placed under the substrate from being directly visible, this masking, however, not being necessary with the substrates selected according to the invention), and/or for other functions. In particular, the worktop can be equipped with a functional layer which confers on it one or more additional properties, such as anti-scratch, mechanical strengthening, anti-fingerprint, anti-overflow, and the like, properties. The coating can, for example, be formed by processes such as screen printing, cathode sputtering or pneumatic spraying deposition, inkjet printing, enamel jet printing, and the like, it being possible for the coating to be applied in particular, depending on the type of coating and on the desired function, to the visible face or to the opposite face. For example, in the case of a decoration by enamel, the latter is preferably deposited on the upper face for reasons of visibility in particular, whereas a coloring layer made of enamel or paint is preferably deposited on the opposite nonobvious face for better protection against abrasion in particular, and the like.

The present invention also relates to a process for the manufacture of an item of equipment according to the invention, in particular of the worktop of said item of equipment, when this worktop is formed of at least one glass-ceramic substrate with a surface area of greater than 0.7 m², in which at least one cycle of ceramization of a glass plate with a surface area of greater than 0.7 m² is carried out in order to obtain said substrate, and according to which the rate of passage is reduced by at least 25%, preferably by at least 50%, or the length of the ceramization furnace or the residence time in said furnace is increased by at least 25%, preferably at least 50%, with respect to the optimal or normal rate, length or residence time respectively, in order to obtain a glass-ceramic substrate with a surface area of less than 0.4 m².

For the record, glass-ceramic plates are generally manufactured as follows: glass with the composition chosen for forming the glass-ceramic is melted in a melting furnace, the molten glass is then rolled to give a standard ribbon or sheet by passing the molten glass between forming rollers, and the glass ribbon is cut to the desired dimensions. Alternatively to the rolling, the glass can be produced by the float glass process, as described, for example, in the patent application WO2008056080, before, if appropriate, being cut up. The plates, already or not yet cut up, are subsequently ceramized in a way known per se, the ceramization consisting in baking the plates according to the temperature profile chosen in order to convert the glass into the polycrystalline material referred to as “glass-ceramic”, the expansion coefficient of which is zero or virtually zero and which withstands a thermal shock which can range up to 700° C. The ceramization generally comprises a stage of gradual rise in the temperature up to the nucleation range, generally located in the vicinity of the range for transformation of the glass; a stage, lasting several minutes, of passing through the nucleation range; a new gradual rise in the temperature up to the temperature of the ceramization stationary phase; the maintenance of the temperature of the ceramization stationary phase for several minutes; and then a rapid cooling down to ambient temperature. If appropriate, the process also comprises a cutting operation (generally before ceramization), for example with a water jet, mechanical marking out with a cutting wheel, and the like, followed by a shaping operation (grinding, beveling, and the like). The process can also comprise a stage of rolling or gravity bending in order to form specific protrusions.

In the present invention, the glass-ceramic follows a ceramization cycle which gives it the desired properties, in particular a relatively clear and scattering translucent or opaque appearance.

Other advantageous characteristics and details will emerge below from the description of a nonlimiting embodiment of the invention, with reference to the appended drawings, in which:

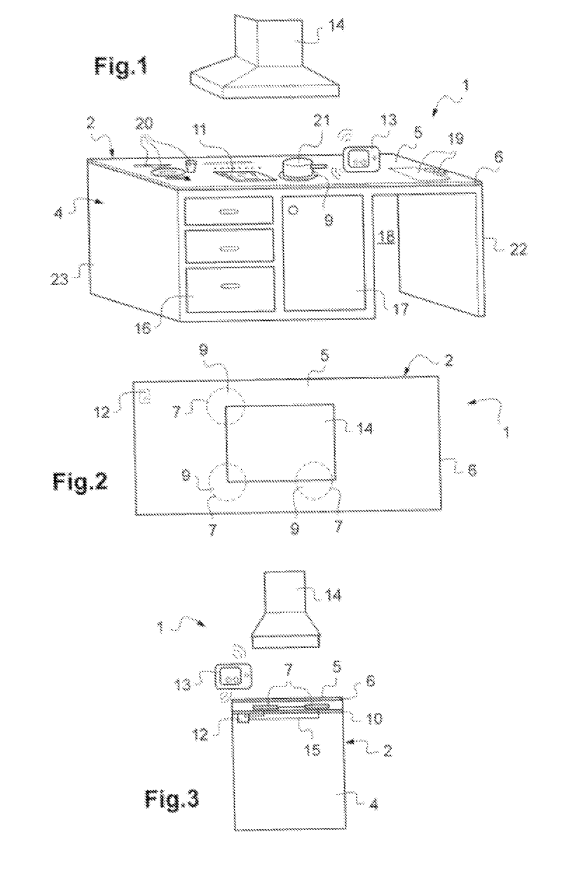

FIG. 1 represents a diagrammatic perspective view of an item of equipment according to the invention;

FIG. 2 represents a diagrammatic top view of a similar item of equipment (the utensils at the surface or the underlying elements of the piece of furniture not being represented);

FIG. 3 represents a diagrammatic side view in which a section of the piece of furniture (23) has been removed in order to reveal certain components of the item of equipment.

In this example, the item of equipment (1) according to the invention comprises a piece of furniture (2) formed of a casing (4) surmounted by a worktop (5) formed of at least one monolithic substrate (6) made of glass-ceramic, this substrate occupying the majority (in this instance all) of the surface (measured on the upper face) of the worktop. This substrate is, for example, a plate of translucent white color of the type of that sold under the KeraWhite reference by Eurokera, this plate exhibiting a surface area of 4.3 m², a smooth upper face and a smooth lower face (it also being possible for this face to be provided with tear drops) and a thickness of 12 mm, and exhibiting a luminosity L* of 88.47, a haze of 97.3%, a light transmission T_{L} of 19.0% and an opacity indicator of 97.0. This substrate is, for example, obtained by proceeding as in the patent application WO9906334 but by reducing the rate of passage in the ceramization furnace by 50%.

This substrate can also, if appropriate, be colored or provided with a resin layer on its lower face, in order to give a coloring to the substrate, for example be provided with a coat of paint based on silicone resin giving a gray coloring, the worktop (coated substrate) thus exhibiting a luminosity L* of 79.45, a haze of 100%, a light transmission T_{L} of 1.53% and an opacity indicator of 99.94, this layer having being applied to the glass-ceramic substrate after it has been prepared.

Alternatively, this substrate can, for example, also be a plate of translucent white color of the type of that sold under the KeraWhite TC reference by Eurokera, this plate exhibiting a surface area of 2.7 m², a smooth upper face and a smooth lower face (it being possible for this face also to be provided with teardrops) and a thickness of 7 mm, exhibiting a luminosity L* of 80.34, a haze of 98.2%, a light transmission T_{L} of 27.2% and an opacity indicator of 94.5.

In both cases, the substrate made of glass-ceramic obtained exhibits a flatness of less than 2 mm (the flatness obtained being between 2 and 3 mm for a rate reduced by only 25% and being more than 15 mm for a rate unchanged with respect to that used in the abovementioned patent application to order to obtain a plate with standard dimensions of less than 0.4 m²), the flatness desired for good optical properties and good coupling and thermal efficiency properties in particular being less than 3 mm and preferably less than 2 mm.

The item of equipment additionally comprises, in the present example, three heating elements (7), for example inductors, positioned under the plate (6) and fastened to a support (10). These inductors are, in the present case, distributed in the middle of the work surface but might just as easily be located at one end of the top.

The item of equipment also comprises decorations (9, 11), for example made of enamel, for example placed on the upper or lower face of the substrate. These decorations, for example in the form of circles of color (9) delimiting each location (it being possible for the colors, if appropriate, to be identical or different according to the locations) and encircling the inductors, make it possible, for example, to signal the cooking locations in order to prevent contact with them when the heating elements are activated. They can also consist of information, logos, images (11), and the like.

The item of equipment additionally comprises at least one interface (12) (hidden by the substrate) for communication with the heating elements, this interface also communicating wirelessly with an external unit in the form, for example, of a touch tablet (13) for the activation of different zones and functions of the plate or of the item of equipment. The external unit can be advantageously movable and lie on the worktop (FIG. 1) or be used for the remote activation (FIG. 3) of different zones or functions. Alternatively or cumulatively, the interface might also comprise or be connected to a permanent control panel located on the surface of the substrate (2) for the activation of different zones and functions, in particular of the substrate.

If appropriate, the item of equipment can also be combined with or comprise a suction hood (14) overhanging the worktop.

The item of equipment also comprises other elements, in particular electrical cables (15) for the activation of the heating elements, and comprises drawers (16) or cupboards (17) inserted into the casing supporting the worktop, for storing various articles, and the like. The item of equipment can also comprise other elements; for example, the worktop can comprise a trim, the substrate can be coated with a localized or nonlocalized fixed decoration, for example made of enamel, the casing can be uninterrupted or comprise different recesses (such as the recess (18)) or integrate other elements (for example a built-in oven, and the like). The worktop (5) can be used for different purposes, such as writing (as symbolized by the paper and the pen (19)), the support for objects (as symbolized by the tableware (20)), while making possible the cooking of food (as symbolized by the cooking receptacles (21)), and the like. If appropriate, the casing can also be replaced by supporting legs (for example only the walls 22 and 23, or four legs at the four corners, the item of equipment under the worktop in this case preferably being hidden by a localized enclosure with a thickness of a few centimeters under the substrate), such as a table.

The item of equipment according to the invention can in particular be advantageously used to produce a new range of interactive and multiuse pieces of furniture in particular integrating cooking zones or a cooking function.

1. An item of equipment, comprising:
at least one worktop formed of at least one substrate made of monolithic glass material with a surface area of greater than 0.7 m², said substrate exhibiting a luminosity L* of greater than 10, a light transmission T_{L} of less than 50%, and an opacity indicator of greater than 90,
at least one heating element,
at least one interface for communication with at least one element of the worktop, and/or with at least one external element for wireless communication,
said item of equipment additionally being devoid of light source(s).

2. The item of equipment as claimed in claim 1, wherein the surface area of the substrate made of glass material is greater than 0.9 m², the thickness of said substrate is at least 2 mm, and the thickness of the substrate is less than 15 mm.

3. The item of equipment as claimed in claim 1, wherein the substrate made of glass material occupies at least 50% of the surface area of the worktop.

4. The item of equipment as claimed in claim 1, wherein the substrate is made of tempered glass or of glass-ceramic.

5. The item of equipment as claimed in claim 1, wherein the substrate exhibits a flatness of less than 0.1% of the diagonal of the substrate.

6. The item of equipment as claimed in claim 1, wherein the substrate is opaque and/or is colored or tinted in its bulk, the coloring including white and any color with a lightness L* of greater than 10, the darker colors, such as black or dark brown, being excluded, and the substrate exhibits a luminosity L* of greater than 15 and/or a haze of greater than 20%, and/or a light transmission T_{L} of less than 32%, and/or an opacity indicator of greater than 95 and of less than or equal to 100, the glass material forming the substrate being translucent or opaque.

7. The item of equipment as claimed in claim 1, wherein the substrate or the glass material comprises colorants and/or is provided with a coating conferring on the substrate or the glass material a different coloring from its own coloring.

8. The item of equipment as claimed in claim 1, wherein the item of equipment comprises, as heating element(s), one or more inductive heating means, the heating element(s) being located in one or more zones of the substrate or uniformly distributed under the substrate.

9. The item of equipment as claimed in claim 1, wherein the cooking locations on the worktop, straight above the heating means, and/or other zones and/or elements and/or functions and/or decorations are signaled by means of a permanent decoration.

10. The item of equipment as claimed in claim 1, wherein the heating element(s) or other component(s) of the item of equipment are capable of being activated by contact on the surface of the worktop and/or on the interface and/or on an external unit, or by movement.

11. The item of equipment as claimed in claim 1, wherein the interface is configured to perform wireless communication with a unit external to the worktop.

12. The item of equipment as claimed in claim 1, wherein the worktop comprises one or more functional and/or decorative coatings.

13. The item of equipment as claimed in claim 1, wherein the worktop is mounted on at least one or more supporting elements, thus forming, with said supporting elements, a table, an uninterrupted or interrupted piece of furniture, or a counter.

14. A worktop, comprising:
at least one substrate made of monolithic glass material with a surface area of greater than 0.7 m², said substrate exhibiting a luminosity L* of greater than 10, a light transmission T_{L} of less than 50%, an opacity indicator of greater than 90 and a haze of greater than 15%.

15. A method, comprising:
obtaining a substrate made of monolithic glass material with a surface area of greater than 0.7 m², said substrate exhibiting a luminosity L* of greater than 10, a light transmission T_{L} of less than 50%, an opacity indicator of greater than 90 and a haze of greater than 15%; and
using the substrate with the item of equipment as claimed in claim 1.

16. The item of equipment as claimed in claim 1, wherein said substrate exhibits a haze of greater than 15%.

17. The item of equipment as claimed in claim 1, wherein the thickness of said substrate is 3 to 30 mm.

18. The item of equipment as claimed in claim 1, wherein the substrate exhibits a flatness of less than 3 mm.

19. The item of equipment as claimed in claim 1, wherein the interface is configured to perform wireless communication with a unit external to the worktop to remotely active the heating zones and/or control different functions of the item of equipment.

20. The item of equipment as claimed in claim 8, wherein the one or more inductive heating means occupies at least 25% of the surface area of the substrate.
